(19) United States
(12) Patent Application Publication
(10) Pub. No.: US 2018/0314477 A1
(43) Pub. Date: Nov. 1, 2018

(54) IMAGE FORMING APPARATUS, NON-TRANSITORY COMPUTER READABLE MEDIUM STORING A CONTROL PROGRAM, AND CONTROL METHOD

(71) Applicant: Sharp Kabushiki Kaisha, Osaka (JP)

(72) Inventor: Tatsuya WATABE, Sakai City (JP)

(21) Appl. No.: 15/955,727

(22) Filed: Apr. 18, 2018

(30) Foreign Application Priority Data
Apr. 27, 2017 (JP) 2017-088556

(51) Int. Cl. G06F 3/12; H04N 1/00

(52) U.S. Cl. CPC G06F 3/1236; G06F 3/1292; H04N 2201/0094; H04N 1/00411; H04N 2201/006; G06F 3/1204

(57) ABSTRACT

An information processing system includes an image forming apparatus and a user terminal. The image forming apparatus includes a wireless communication unit by which wireless communication is performed with the user terminal. A CPU of the image forming apparatus stops the wireless communication unit (first state) when wireless communication is not performed, and causes the wireless communication unit to operate (second state) when a predetermined first operation is received in the image forming apparatus.

### BACKGROUND

### 1. Field

The present disclosure relates to an image forming apparatus, a non-transitory computer readable medium storing a control program, and a control method, and particularly relates to an image forming apparatus that is able to perform wireless communication with a portable terminal, and a non-transitory computer readable medium storing a control program and a control method thereof, for example.

### 2. Description of the Related Art

An example of such kind of related arts is disclosed in Japanese Unexamined Patent Application Publication No. 2016-187088. An image forming apparatus of such a related art includes a WiFi (registered trademark) I/F, a BT (Bluetooth; registered trademark) I/F, and an NFC I/F. When a predetermined signal is received from a portable terminal via the BT I/F while a state of each of the WiFi I/F and the NFC I/F is a Standby state, the image forming apparatus of the related art changes the state of each of the WiFi I/F and the NFC I/F from the Standby state to an ON state. Then, the image forming apparatus of the related art transmits, to the portable terminal, network information for establishing WiFi connection by NFC communication and performs transmission/reception of communication data with the portable terminal by using WiFi.

However, in the image forming apparatus of the related art, the BT I/F is constantly maintained in the ON state for receiving the predetermined signal from the portable terminal. That is, power is constantly supplied to the BT I/F and a state in which BT communication is allowed is maintained.

Furthermore, in order to receive radio waves, power is being supplied to the WiFi I/F and the NFC I/F that are in the Standby state.

As above, in the image forming apparatus of the related art, even when the WiFi connection is not performed, power is being supplied to the BT I/F, the WiFi I/F, and the NFC I/F, so that it is difficult to achieve power saving appropriately and thus there is room for improvement.

Therefore, the disclosure provides an image forming apparatus, a control program, and a control method that are new.

The disclosure also provides an image forming apparatus, a control program, and a control method that are able to achieve power saving appropriately.

### SUMMARY

The disclosure provides an image forming apparatus that includes a wireless communication unit configured to wireless communication with a portable terminal, an operation determination unit, and a communication control unit. The operation determination unit is configured to determine whether or not a first operation by which the image forming apparatus is caused to execute a function that includes the wireless communication is performed. The communication control unit is configured to shift a state of the wireless communication unit from a first state in which the wireless communication is not allowed to a second state in which the wireless communication is allowed, in a case where the operation determination unit determines that the first operation is performed.

The disclosure provides a non-transitory computer readable medium storing a program causing a computer to execute a process for controlling an image forming apparatus including a wireless communication unit by which wireless communication is performed with a portable terminal. The process includes causing a processor of the image forming apparatus to function as an operation determination unit configured to determine whether or not a first operation by which the image forming apparatus is caused to execute a function that includes the wireless communication is performed and a communication control unit configured to shift a state of the wireless communication unit from a first state in which the wireless communication is not allowed to a second state in which the wireless communication is allowed, in a case where the operation determination unit determines that the first operation is performed.

The disclosure provides a control method, in which a processor of an image forming apparatus that includes a wireless communication unit configured to perform wireless communication with a portable terminal executes (a) determining whether or not a first operation by which the image forming apparatus is caused to execute a function that includes the wireless communication is performed, and (b) shifting a state of the wireless communication unit from a first state in which the wireless communication is not allowed to a second state in which the wireless communication is allowed, in a case where it is determined, at (a), that the first operation is performed.

Features and advantages of the disclosure will be further apparent from detailed description of exemplary embodiments below with reference to drawings.

### BRIEF DESCRIPTION OF THE DRAWINGS

FIG. 1 illustrates an example of a configuration of an information processing system of the disclosure;

FIG. 2 is a block diagram illustrating an electrical configuration of an image forming apparatus illustrated in FIG. 1;

FIG. 3 is a block diagram illustrating an electrical configuration of a user terminal illustrated in FIG. 1;

FIG. 4 is an explanatory diagram illustrating an example of a home screen of the image forming apparatus;

FIG. 5 is an explanatory diagram illustrating an example of a connection guide screen of the image forming apparatus;

FIG. 6 is an explanatory diagram illustrating an example of a memory map of a RAM of the image forming apparatus illustrated in FIG. 1;

FIG. 7 is an explanatory diagram illustrating an example of a memory map of a RAM of the user terminal illustrated in FIG. 1;

FIG. 8 is a flowchart illustrating an example of communication processing of a CPU of the image forming apparatus;

FIG. 9 is a block diagram illustrating an electrical configuration of an image forming apparatus of a second exemplary embodiment;

FIG. 10 is an explanatory diagram illustrating an example of the home screen of the image forming apparatus;

FIG. 11 is a flowchart illustrating an example of communication processing of the second exemplary embodiment;

FIG. 12 is a flowchart illustrating an example of communication processing of a third exemplary embodiment; and

FIG. 13 is an explanatory diagram illustrating an example of a setting screen of a modified example.

### DESCRIPTION OF THE EMBODIMENTS

### First Exemplary Embodiment

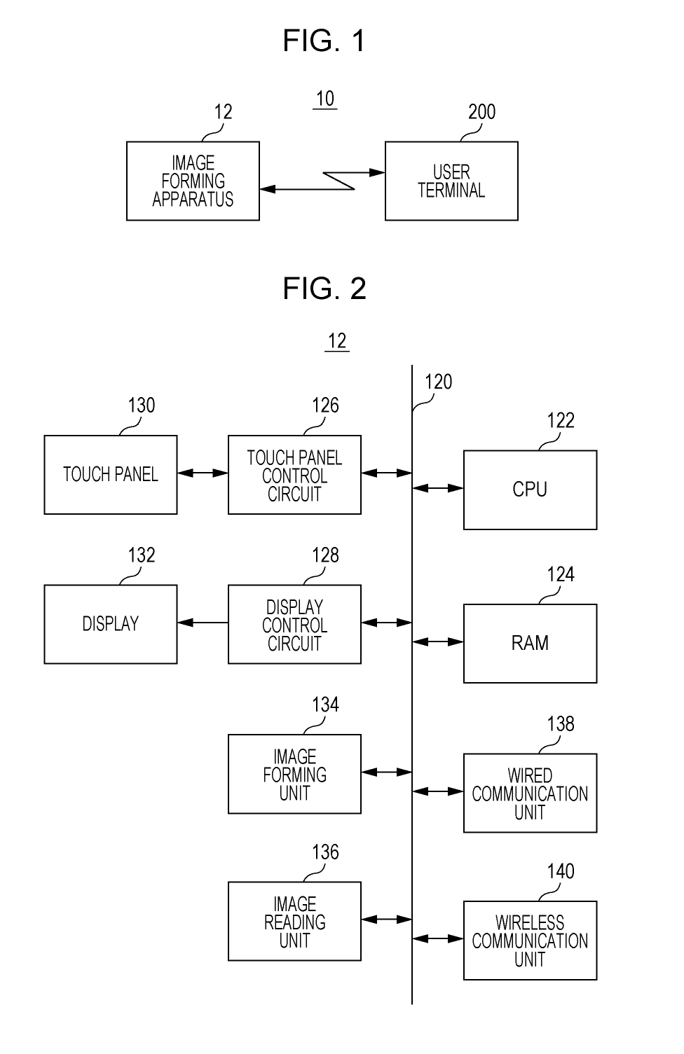

FIG. 1 illustrates an example of a configuration of an information processing system 10 of the disclosure. Referring to FIG. 1, the information processing system 10 of a first exemplary embodiment of the disclosure includes an image forming apparatus 12 and the image forming apparatus 12 is connected with a network such as the Internet through a communication cable or the like. The image forming apparatus 12 is connected with a portable terminal (user terminal) 200 so as to be able to perform wireless communication.

Note that, one image forming apparatus 12 and one user terminal 200 are illustrated in FIG. 1, but two or more image forming apparatuses 12 and two or more user terminals 200 may be included.

In the first exemplary embodiment, the image forming apparatus 12 is a multifunction peripheral (MFP) that has a copying function, a printer function, a scanner function, a facsimile function, or the like. Note that, the disclosure is applicable not only to the multifunction peripheral but also to other image forming apparatuses such as a copying machine (copier), a printing apparatus (printer), and a facsimile.

FIG. 2 is a block diagram illustrating an electrical configuration of the image forming apparatus 12 illustrated in FIG. 1. Referring to FIG. 2, the image forming apparatus 12 includes a CPU 122. The CPU 122 is connected with a RAM 124, a touch panel control circuit 126, a display control circuit 128, an image forming unit 134, an image reading unit 136, a wired communication unit 138, and a wireless communication unit 140 via a bus 120. The touch panel control circuit 126 is connected with a touch panel 130 and the display control circuit 128 is connected with a display 132. As the display 132, an LCD, an EL (Electro-Luminescence) display, or the like may by used, for example. The same is also applied to a display 212 of the user terminal 200 that is described later. In the first exemplary embodiment, as the touch panel 130, a touch panel of an electrostatic capacitive system is used and the touch panel 130 is provided on a display surface of the display 132. However, a touch panel display in which the touch panel 130 and the display 132 are integrally formed may be used. The touch panel 130 is not necessarily limited to one of the electrostatic capacitive system and one of any system such as an electromagnetic induction system, a resistance film system, or an infrared system may be used. The same is applied to a touch panel 210 of the user terminal 200 that is described later.

The CPU 122 controls the entire image forming apparatus 12. The RAM 124 is used as a work area and a buffer area of the CPU 122.

The touch panel control circuit 126 applies a desired voltage or the like to the touch panel 130 and, upon detection of a touch operation (touch input) within a touch effective range in the touch panel 130, outputs, to the CPU 122, touch coordinate data indicating a position of the touch input.

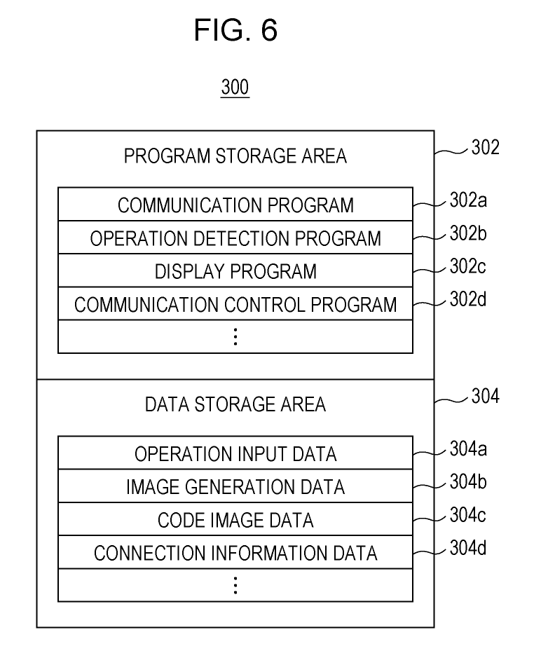

The display control circuit 128 includes a GPU, a VRAM, and the like. Under an instruction of the CPU 122, by using image generation data 304b (refer to FIG. 6) stored in the RAM 124, the GPU generates, in the VRAM, display image data for displaying various screens on the display 132 and outputs the generated display image data to the display 132. As an example, on the display 132, a home screen 100 (refer to FIG. 4) that is a screen for selecting a desired job among various jobs which are able to be executed by the image forming apparatus 12 is displayed. In the first exemplary embodiment, a job means copying (including scanning of an original document), printing, transmission of a facsimile, or the like.

The image forming unit (printing device) 134 is a general-purpose laser printer and includes a photoreceptor, a charger, an exposure device, a developing device, a transfer device, a fixing device, and the like to print, on a recording sheet (sheet) or the like, an image that corresponds to print data which is processed by an image processing circuit. However, the image forming unit 134 may be constituted by an inkjet printer instead of the laser printer.

The image reading unit 136 includes a light source, a plurality of mirrors, an image forming lens, a line sensor, and the like. The image reading unit 136 exposes a surface of an original document with use of the light source and guides reflected light, which is reflected from the surface of the original document, to the image forming lens by the plurality of mirrors. Then, an image of the reflected light is formed on a light receiving element of the line sensor by the image forming lens. In the line sensor, luminance and chromaticity of the reflected light whose image is formed on the light receiving element are detected and read image data is generated on the basis of an image of the surface of the original document.

The wired communication unit 138 performs transmission/reception processing of communication data, which is to be transmitted to/received from an external computer such as a server, on the basis of a wired communication system conforming to a known communication standard such as Ethernet (registered trademark) via a network such as the Internet.

The wireless communication unit 140 includes a wireless communication circuit. The wireless communication circuit is a circuit for performing wireless communication such as WiFi and is connected with an antenna. The wireless communication unit 140 performs transmission/reception processing of communication data, which is to be transmitted to/received from the user terminal 200, by using the wireless communication such as WiFi on the basis of a wireless communication system conforming to a known communication standard such as IEEE 802.11. The image forming apparatus 12 also functions as an access point for wireless communication (for example, an access point for WiFi connection) via the wireless communication unit 140. That is, the wireless communication unit 140 modulates communication data to the user terminal 200 into a wireless signal (radio wave signal) by the wireless communication circuit and transmits the wireless signal from the antenna, and also receives a wireless signal from the user terminal 200 by the same antenna and demodulates the wireless signal into communication data by the wireless communication circuit. The same is applied to a wireless communication unit 216 of the user terminal 200 that is described later.

Note that, the electrical configuration of the image forming apparatus 12 illustrated in FIG. 2 is merely an example and there is no limitation thereto. For example, in the image forming apparatus 12, as a different input unit, an operation button of hardware such as an operation panel is provided or a keyboard of hardware is connected in some cases.

The user terminal 200 is a portable terminal that is able to be carried and examples thereof include a smartphone, a feature phone, and a tablet PC each of which is used for various purposes. The user terminal 200 includes various functions, for example, such as a speech communication function, an electronic mail function, and a browser function.

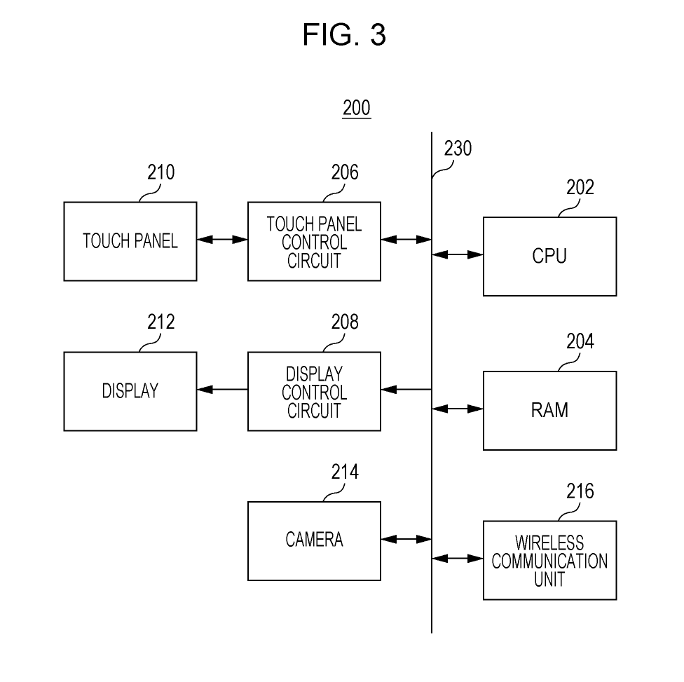

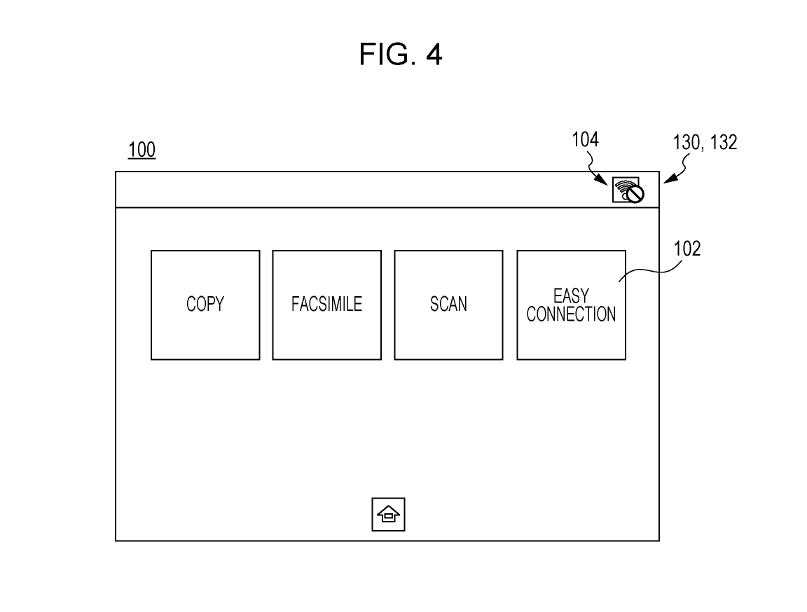

FIG. 3 is a block diagram illustrating an electrical configuration of the user terminal 200 illustrated in FIG. 1. Referring to FIG. 3, the user terminal 200 of the first exemplary embodiment includes a CPU 202. The CPU 202 is connected with a RAM 204, a touch panel control circuit 206, a display control circuit 208, a camera 214, and the wireless communication unit 216 via a bus 230. The touch panel control circuit 206 is connected with a touch panel 210 and the display control circuit 208 is connected with the display 212.

The CPU 202 controls the entire user terminal 200. The RAM 204 is used as a work area and a buffer area of the CPU 202.

The wireless communication unit 216 includes a wireless communication circuit, an antenna, and the like and performs transmission/reception processing of communication data, which is to be transmitted to/received from the image forming apparatus 12, by using wireless communication on the basis of a wireless communication system conforming to a known communication standard.

The touch panel control circuit 206 applies a desired voltage or the like to the touch panel 210 and, upon detection of a touch operation (touch input) within a touch effective range in the touch panel 210, outputs, to the CPU 202, touch coordinate data indicating a position of the touch input.

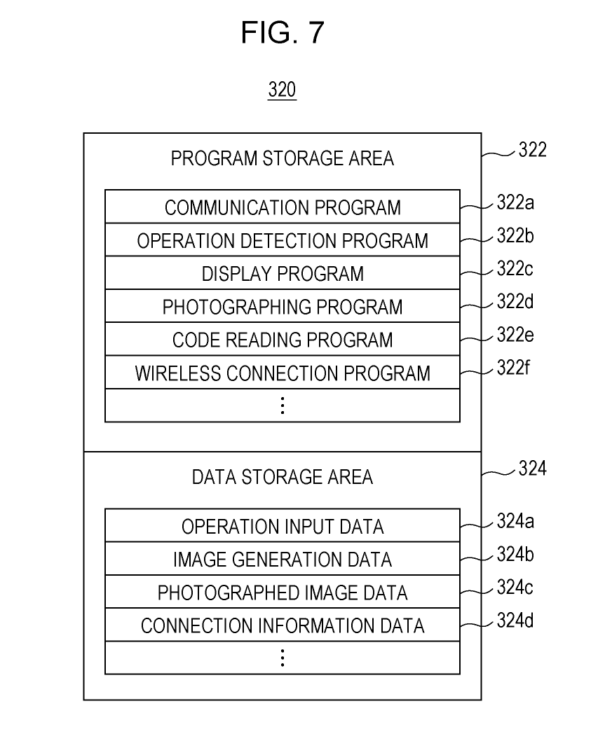

The display control circuit 208 includes a GPU, a VRAM, and the like. Under an instruction of the CPU 202, by using image generation data 324b (refer to FIG. 7) stored in the RAM 204, the GPU generates, in the VRAM, display image data for displaying various screens on the display 212 and outputs the generated display image data to the display 212.

The camera 214 has an image sensor and a focus lens whose position is able to be adjusted and captures an image by converting imaging light as visible light, which is taken from the image sensor, into an electrical signal. An example of the image sensor includes a solid state image sensor such as a CCD (Charge Coupled Device) image sensor or a CMOS (Complementary Metal Oxide Semiconductor) image sensor. Photographed image data output from the camera 214 is input to the CPU 202 and temporarily stored in the RAM 204.

Note that, the electrical configuration of the user terminal 200 illustrated in FIG. 3 is merely an example and there is no limitation thereto. For example, in the user terminal 200, as a different input unit, an operation button of hardware is provided in some cases. Furthermore, in FIG. 3, a component related to speech communication or the like is omitted for simplification.

In the information processing system 10 having such a configuration, the image forming apparatus 12 is able to function as the access point for wireless communication and perform transmission/reception of communication data with the user terminal 200 by using the wireless communication.

However, there is a problem that, in a case where the wireless communication unit 140 of the image forming apparatus 12 is activated even when wireless communication is not performed, power is consumed uselessly. Additionally, there is a problem that radio waves from the wireless communication unit 140 of the image forming apparatus 12 and radio waves from different communication equipment interfere with each other, resulting in that communication quality of the different communication equipment is deteriorated.

Accordingly, in order to avoid such inconvenience, the information processing system 10 of the first exemplary embodiment stops the wireless communication unit 140 of the image forming apparatus 12 when wireless communication is not performed, and causes the wireless communication unit 140 of the image forming apparatus 12 to operate (be activated) when a predetermined user operation (first operation) by which the image forming apparatus 12 is caused to execute a function including wireless communication is received.

However, when the wireless communication unit 140 of the image forming apparatus 12 is stopped, the image forming apparatus 12 is brought into a state (first state) in which wireless communication is not allowed. When the image forming apparatus 12 is in the first state, supply of power to the wireless communication unit 140 is stopped.

When the wireless communication unit 140 of the image forming apparatus 12 is activated, the image forming apparatus 12 is brought into a state (second state) in which wireless communication is allowed. When the image forming apparatus 12 is in the second state, power is supplied to the wireless communication unit 140 so that wireless communication is allowed.

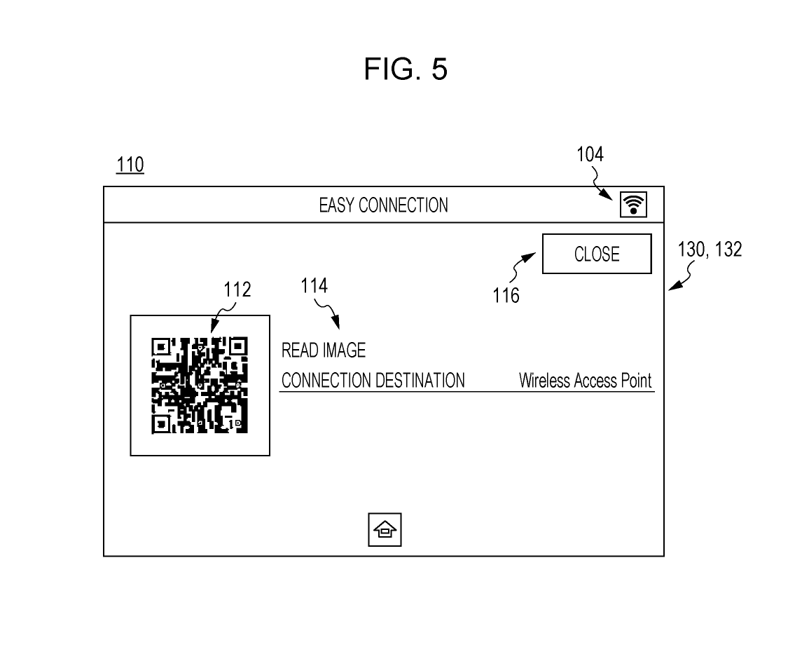

Hereinafter, an example of an operation of the information processing system 10 will be described with reference to FIG. 4 and FIG. 5. FIG. 4 is an explanatory diagram illustrating an example of the home screen 100 of the image forming apparatus 12. FIG. 5 is an explanatory diagram illustrating an example of a connection guide screen 110 of the image forming apparatus 12.

When a main power supply of the image forming apparatus 12 is turned on and the image forming apparatus 12 is in a standby state in which various functions are able to be executed, the home screen 100 as illustrated in FIG. 4 is displayed on the display 132 of the image forming apparatus 12. The home screen 100 is a screen for selecting various jobs as described above. In the home screen 100, an image of a software key (icon) for selecting each of the jobs of copying, facsimile, scanning, and the like is displayed. Additionally, an image of a software key (hereinafter, referred to as a “connection icon”) 102 for starting wireless communication with the user terminal 200 is displayed in the home screen 100.

Moreover, a communication state image 104 in which information indicating whether or not wireless communication is allowed (whether or not the wireless communication unit 140 is activated) is displayed in a simplified manner is displayed in an upper part of the home screen 100. In the example illustrated in FIG. 4, the image forming apparatus 12 is in the first state and the wireless communication unit 140 is stopped. Thus, information indicating that wireless communication is not allowed is displayed in the communication state image 104.

When the connection icon 102 is touched (selected), the connection guide screen 110 as illustrated in FIG. 5 is displayed on the display 132 of the image forming apparatus 12.

In the first exemplary embodiment, the first operation by which the wireless communication unit 140 is activated is an operation of touching the connection icon 102. Accordingly, when the connection icon 102 is touched, a state of the image forming apparatus 12 is shifted from the first state to the second state. That is, power is supplied to the wireless communication unit 140 and wireless communication is allowed. Therefore, the information indicating that wireless communication is allowed is displayed in the communication state image 104 of the connection guide screen 110.

A code image 112, a message 114, and a closing icon 116 are displayed on the connection guide screen 110. Thus, it is also possible to say that the first operation is an operation by which the code image 112 is displayed on the display 132.

The message 114 includes an indication urging a user to read the code image 112 by the user terminal 200, information of a connection destination, and the like. The closing icon 116 is a software key to close the connection guide screen 110 and return to the home screen 100.

The code image 112 is, for example, a two-dimensional code. The two-dimensional code may be a matrix two-dimensional code such as a QR code (registered trademark), a micro QR code, a DataMATRIX code, a MaxiCODE, or a VeriCODE and may be a stacked two-dimensional code such as a PDF417 format, or a CODE49. Connection information (an SSID (Service Set Identifier), an encryption key, and the like) for wireless communication specific to the image forming apparatus 12 is embedded in the code image 112.

Additionally, the communication state image 104 is displayed in the upper part of the connection guide screen 110 similarly to the home screen 100. In the example illustrated in FIG. 5, the image forming apparatus 12 is in the second state and the wireless communication unit 140 is activated. Thus, information indicating that wireless communication is allowed is displayed in the communication state image 104.

Note that, the connection guide screen 110 becomes non-displayed (returns to the home screen 100) when the closing icon 116 is touched or when a predetermined time (for example, three to five minutes) elapses after the connection guide screen 110 is displayed on the display 132.

Here, when the connection guide screen 110 is displayed on the display 132, a user activates a predetermined application, which is used for reading the code image 112, in the user terminal 200 and photographs the code image 112 by the camera 214. The user terminal 200 extracts the code image 112 from the photographed image and decodes the extracted code image 112.

After the code image 112 is decoded, the user terminal 200 acquires the connection information for wireless communication, which is embedded in the code image 112. When acquiring the connection information for wireless communication, the user terminal 200 automatically establishes wireless communication connection with the image forming apparatus 12 in accordance with the connection information for wireless communication.

When the wireless communication connection is established between the user terminal 200 and the image forming apparatus 12, transmission/reception of communication data is able to be performed between the user terminal 200 and the image forming apparatus 12 by wireless communication. For example, transmission image data used for transmission of a facsimile, transmission destination data used for transmission of a facsimile, print image data, or the like is transmitted from the user terminal 200 to the image forming apparatus 12 or read image data that is read by the image reading unit 136 or the like is transmitted from the image forming apparatus 12 to the user terminal 200. Additionally, by transmitting an operation signal from the user terminal 200 to the image forming apparatus 12, it is possible to remotely operate the image forming apparatus 12. Moreover, the user terminal 200 is connected to a network via the image forming apparatus 12, so that Web browsing is also able to be performed by the user terminal 200.

Note that, when the first operation is performed in the second state (state in which the wireless communication unit 140 is activated), the second state is maintained without a shift to the first state (state in which the wireless communication unit 140 is stopped).

When the CPU 122 of the image forming apparatus 12 executes an information processing program for the image forming apparatus 12 which is stored in the RAM 124 and the CPU 202 of the user terminal 200 executes an information processing program for the user terminal 200 which is stored in the RAM 204, an operation of the information processing system 10 as described above is realized. Specific processing will be described later by using a flowchart.

FIG. 6 is an explanatory diagram illustrating an example of a memory map 300 of the RAM 124 of the image forming apparatus 12 which is illustrated in FIG. 2. As illustrated in FIG. 6, the RAM 124 includes a program storage area 302 and a data storage area 304. As above, the information processing program for the image forming apparatus 12 is stored in the program storage area 302 of the RAM 124. The information processing program for the image forming apparatus 12 includes a communication program 302a, an operation detection program 302b, a display program 302c, and a communication control program 302d.

The communication program 302a is a program for controlling the wired communication unit 138 so as to perform communication (transmission/reception) of data with an external computer such as a server in a wired manner via a network. The communication program 302a is also a program for controlling the wireless communication unit 140 so as to perform transmission/reception of data in a wireless manner with the user terminal 200.

The operation detection program 302b is a program for detecting a touch input, and the CPU 122 acquires, in accordance with the operation detection program 302b, touch coordinate data output from the touch panel 130 and stores the acquired touch coordinate data in the RAM 124 in time series. For example, the operation detection program 302b is a program for detecting, in accordance with the touch coordinate data output from the touch panel 130, that a software key such as the connection icon 102 is touched. However, as above, when a button of hardware is provided or when a keyboard of hardware is connected, an input of the button or a key is also detected in accordance with the operation detection program 302b.

The display program 302c is a program for generating display image data, that is, screen data such as the aforementioned home screen 100 or connection guide screen 110 by using image generation data 304b described later, and outputting the screen data to the display 132.

The communication control program 302d is a program for activating or stopping the wireless communication unit 140. That is, the communication control program 302d is a program for sifting the state of the image forming apparatus 12 from the first state to the second state or from the second state to the first state. For example, the communication control program 302d is a program for activating the wireless communication unit 140 when, in the state in which the wireless communication unit 140 is stopped, it is detected, in accordance with the operation detection program 302b, that the connection icon 102 is touched.

Though illustration is omitted, in the program storage area 302, an image reading program, an image forming program, and the like are stored. The image reading program is a program for controlling the image reading unit 136 to read an image of an original document and outputting an image signal (read image data) corresponding to the read image. The image forming program is a program for controlling the image forming unit 134 to print a multicolor or monochromatic image on a sheet. In the program storage area 302, a program for selecting and executing various functions included in the image forming apparatus 12 and the like are also stored.

Additionally, in the data storage area 304 of the RAM 124, operation input data 304a, the image generation data 304b, code image data 304c, connection information data 304d, and the like are stored.

The operation input data 304a is data in which the touch coordinate data that is detected in accordance with the operation detection program 302b is stored in time series. However, in the operation input data 304a, operation data about a button or a key of hardware is included in some cases.

The image generation data 304b is data, such as polygon data or texture data, for generating each display image data corresponding to each of various screens to be displayed on the display 132.

The code image data 304c is data corresponding to the code image 112 in which the connection information data 304d is embedded.

The connection information data 304d is data corresponding to the connection information for wireless communication specific to the image forming apparatus 12. For example, the connection information data 304d is data corresponding to the SSID, the encryption key, and the like.

Note that, though illustration is omitted, in the data storage area 304, different data which is desired for executing the information processing program for the image forming apparatus 12 is stored and a timer (counter) or a register each of which is desired for executing the information processing program for the image forming apparatus 12 is provided.

FIG. 7 is an explanatory diagram illustrating an example of a memory map 320 of the RAM 204 of the user terminal 200 illustrated in FIG. 3. As illustrated in FIG. 7, the RAM 204 includes a program storage area 322 and a data storage area 324. As above, the information processing program for the user terminal 200 is stored in the program storage area 322 of the RAM 204. The information processing program for the user terminal 200 includes a communication program 322a, an operation detection program 322b, a display program 322c, a photographing program 322d, a code reading program 322e, and a wireless connection program 322f.

The communication program 322a is a program for controlling the wireless communication unit 216 so as to perform transmission/reception of data in the wireless manner with the image forming apparatus 12.

The operation detection program 322b is a program for detecting a touch input, and the CPU 202 acquires, in accordance with the operation detection program 322b, touch coordinate data output from the touch panel 210 and stores the acquired touch coordinate data in the RAM 204 in time series. However, as above, when an operation button of hardware is provided, an input of the operation button is also detected in accordance with the operation detection program 322b.

The display program 322c is a program for generating various kinds of screen data by using the image generation data 324b described later and outputting the screen data to the display 212.

The photographing program 322d is a program for controlling the camera 214 so as to acquire a photographed image.

The code reading program 322e is a program for extracting the code image 112 from the photographed image that is photographed in accordance with the photographing program 322d and decoding the extracted code image 112. The code reading program 322e is also a program for decoding the code image 112 to thereby acquire the same data (connection information data 324d) as the connection information data 304d included in the code image 112.

The wireless connection program 322f is a program for establishing wireless communication connection with the image forming apparatus 12 by using the connection information data 324d described later.

Note that, though illustration is omitted, in the program storage area 322, a program for selecting and executing various functions included in the user terminal 200 and the like are also stored.

Additionally, in the data storage area 324 of the RAM 204, operation input data 324a, the image generation data 324b, photographed image data 324c, the connection information data 324d, and the like are stored.

The operation input data 324a is data in which the touch coordinate data that is detected in accordance with the operation detection program 322b is stored in time series. However, in the operation input data 324a, operation data about a button of hardware is included in some cases.

The image generation data 324b is data, such as polygon data or texture data, for generating each display image data corresponding to each of various screens to be displayed on the display 212.

The photographed image data 324c is image data about a photographed image that is photographed by the camera 214 in accordance with the photographing program 322d.

The connection information data 324d is the same data as the aforementioned connection information data 304d and is data corresponding to the connection information for wireless communication specific to the image forming apparatus 12.

Note that, though illustration is omitted, in the data storage area 324, different data which is desired for executing the information processing program for the user terminal 200 is stored and a timer (counter) or a register each of which is desired for executing the information processing program for the user terminal 200 is provided.

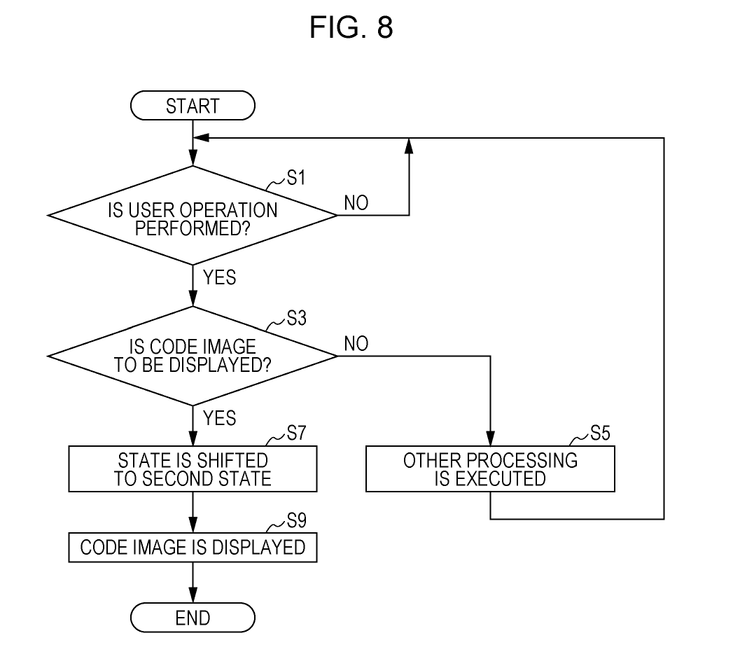

FIG. 8 is a flowchart illustrating an example of communication processing that is executed by the CPU 122 of the image forming apparatus 12 illustrated in FIG. 2. The communication processing is started when a power source of the image forming apparatus 12 is turned on. However, it is set that the image forming apparatus 12 is in the first state (the wireless communication unit 140 is stopped) when the communication processing is started.

As illustrated in FIG. 8, when starting the communication processing, the CPU 122 of the image forming apparatus 12 determines, at step S1, whether or not a user operation is performed. Here, it is determined whether or not touch coordinate data is input from the touch panel 130 or whether or not operation data of a button or a key of hardware is input.

In a case of “NO” at step S1, that is, when the user operation is not performed, the procedure returns to the same step S1. On the other hand, in a case of “YES” at step S1, that is, when the user operation is performed, whether or not an operation (first operation) by which the code image 112 is displayed on the display 132 is performed is determined at step S3. Here, it is determined whether or not the connection icon 102 is touched.

In a case of “NO” at step S3, that is, when an operation other than the operation by which the code image 112 is displayed on the display 132 is performed, other processing is executed at step S5 and the procedure returns to step S1. The other processing that is executed at step S5 includes processing in which each of jobs is selected in accordance with an instruction of a user, processing in which various kinds of setting are performed in each job, and processing in which each job is started or stopped.

On the other hand, in a case of “YES” at step S3, that is, when the operation by which the code image 112 is displayed on the display 132 is performed, the state is shifted to the second state at step S7. That is, the wireless communication unit 140 is activated and the wireless communication is allowed.

Next, the code image 112 is displayed on the display 132 at step S9 and then the communication processing ends.

According to the first exemplary embodiment, the wireless communication unit 140 of the image forming apparatus 12 is stopped when wireless communication is not performed, and the wireless communication unit 140 of the image forming apparatus 12 is activated when the first operation is received in the image forming apparatus 12, so that power saving is able to be achieved appropriately.

Additionally, it is possible to suppress deterioration in communication quality in different communication equipment, which is caused due to radio wave interference, because the wireless communication unit 140 of the image forming apparatus 12 is stopped when wireless communication is not performed.

Moreover, according to the first exemplary embodiment, when a user desires to activate the wireless communication unit 140, an operation therefor is easy, since it is only desired to perform the operation by which the code image 112 is displayed on the display 132.

### Second Exemplary Embodiment

Since the information processing system 10 of a second exemplary embodiment is the same as that of the first exemplary embodiment except that the image forming apparatus 12 and the user terminal 200 are configured to be able to perform short distance wireless communication with each other, a content different from that of the first exemplary embodiment will be described and duplicate description will be omitted.

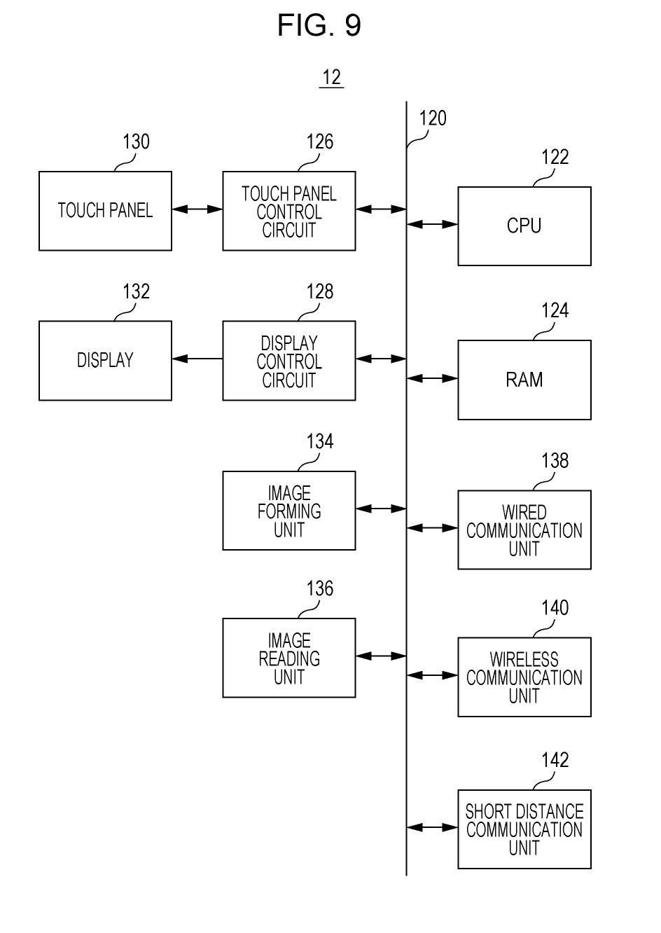

FIG. 9 is a block diagram illustrating an electrical configuration of the image forming apparatus 12 illustrated in FIG. 1. As illustrated in FIG. 9, the image forming apparatus 12 includes a short distance communication unit 142. The short distance communication unit 142 is connected with the CPU 122 via the bus 120. Though illustration is omitted, the short distance communication unit 142 is arranged, for example, near the display 132.

The short distance communication unit 142 performs transmission/reception of communication data with the user terminal 200 by short distance wireless communication in accordance with a communication standard, for example, such as a communication standard of ISO/IEC 18092 (known as NFC (Near Field Communication)), or the like.

Though illustration is omitted, the user terminal 200 includes a short distance communication unit that has the same configuration as that of the aforementioned short distance communication unit 142. The short distance communication unit of the user terminal 200 is connected with the CPU 202 via the bus 230.

In the second exemplary embodiment, when the short distance communication unit of the user terminal 200 is brought close to (held over) the short distance communication unit 142 of the image forming apparatus 12 so as to be within a communication available distance, short distance wireless communication connection is automatically established. Note that, the communication available distance is about several centimeters to ten-odd centimeters.

When the short distance wireless communication connection is established between the image forming apparatus 12 and the user terminal 200, transmission/reception of communication data is able to be performed between the user terminal 200 and the image forming apparatus 12 by short distance wireless communication.

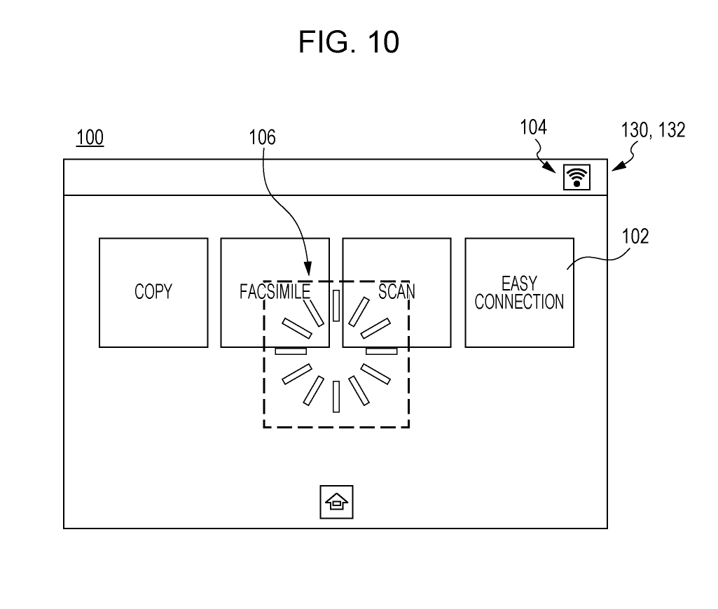

Hereinafter, an example of an operation of the information processing system 10 will be described with reference to FIG. 10. FIG. 10 is an explanatory diagram illustrating an example of the home screen 100 of the image forming apparatus 12.

When the image forming apparatus 12 is in the standby state, the home screen 100 (refer to FIG. 4) is displayed on the display 132 of the image forming apparatus 12 similarly to the first exemplary embodiment.

In the second exemplary embodiment, the first operation by which the wireless communication unit 140 is activated is an operation by which short distance wireless communication is started (operation of holding the user terminal 200 over the short distance communication unit 142 of the image forming apparatus 12). Therefore, when the user terminal 200 is held over the short distance communication unit 142 of the image forming apparatus 12, short distance wireless communication is started. When the short distance wireless communication with the user terminal 200 is started, the state of the image forming apparatus 12 is shifted from the first state to the second state.

Moreover, when the short distance wireless communication is started between the image forming apparatus 12 and the user terminal 200, connection information for wireless communication is transmitted from the image forming apparatus 12 to the user terminal 200 by short distance wireless communication. The user terminal 200 automatically establishes wireless communication connection with the image forming apparatus 12 in accordance with the connection information for wireless communication which is received.

In this case, when the short distance wireless communication is started, a predetermined image (icon) 106 indicating that short distance wireless communication is being performed is displayed on the home screen 100 of the display 132 of the image forming apparatus 12 as illustrated in FIG. 10. Note that, the icon 106 is displayed when short distance wireless communication is started between the image forming apparatus 12 and the user terminal 200 and becomes non-displayed when transmission/reception of communication data between the image forming apparatus 12 and the user terminal 200 ends.

Note that, the communication program 302a of the second exemplary embodiment is also a program for controlling the short distance communication unit 142 so as to perform transmission/reception of data with the user terminal 200 by short distance wireless communication. Additionally, the communication program 322a of the second exemplary embodiment is also a program for controlling the short distance communication unit of the user terminal 200 so as to perform transmission/reception of data with the image forming apparatus 12 by short distance wireless communication. Moreover, in the second exemplary embodiment, the code reading program 322e may be omitted.

Hereinafter, communication processing in the second exemplary embodiment will be described by using a flowchart, and processing that is the same as the communication processing described in the first exemplary embodiment will be given the same reference sign and duplicate description will be omitted or simplified.

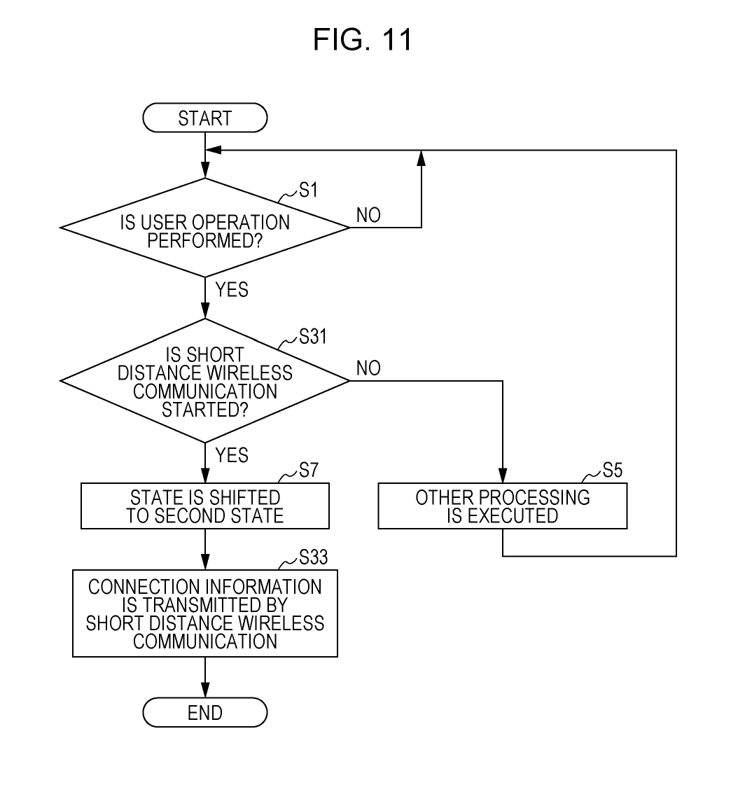

FIG. 11 is a flowchart illustrating an example of the communication processing of the second exemplary embodiment. As illustrated in FIG. 11, when the communication processing is started, in a case of “YES” at step S1, that is, in a case where a user operation is performed, the CPU 122 of the image forming apparatus 12 determines, at step S31, whether or not an operation by which short distance wireless communication is started is performed. Here, it is determined whether or not an operation of holding the user terminal 200 over the short distance communication unit 142 of the image forming apparatus 12 is performed.

In a case of “NO” at step S31, that is, when an operation other than the operation by which short distance wireless communication is started is performed, the procedure proceeds to step S5. On the other hand, in a case of “YES” at step S31, that is, when the operation by which short distance wireless communication is started is performed, at step S7, the state is shifted to the second state, and at step S33, the connection information for wireless communication is transmitted to the user terminal 200 by short distance wireless communication, and then the communication processing ends.

Note that, contents of processing at step S1 and processing at step S5 are the same as those of the first exemplary embodiment, so that description thereof will be omitted.

According to the second exemplary embodiment, power saving is able to be achieved appropriately similarly to the first exemplary embodiment. Additionally, according to the second exemplary embodiment, it is possible to suppress deterioration in communication quality in different communication equipment, which is caused due to radio wave interference.

Moreover, according to the second exemplary embodiment, when a user desires to activate the wireless communication unit 140, an operation therefor is easy, since it is only desired to hold the user terminal 200 over the short distance communication unit 142 of the image forming apparatus 12.

Note that, in the second exemplary embodiment, the state of the image forming apparatus 12 is to be shifted to the second state unconditionally when the operation by which short distance wireless communication is started is performed, but there is no limitation thereto. For example, when an operation (second operation) by which short distance wireless communication is started for a purpose other than operating a function of the image forming apparatus 12 by wireless communication is performed, the state of the image forming apparatus 12 may be temporarily shifted to the second state and, after a predetermined time (for example, about three to ten seconds) has elapsed, the state may be shifted to the first state. In a case where the second operation is performed before short distance wireless communication is started, the state of the image forming apparatus 12 may not be shifted to the second state even when the operation by which short distance wireless communication is started is performed. An example of the second operation includes an operation of performing user authentication (operation of holding the user terminal 200, an ID card, or the like over the short distance communication unit 142). This is because, when short distance wireless communication is used only for user authentication, the wireless communication is not used after the user authentication in some cases. Therefore, in a case where a user authentication mode is executed (for example, a login screen or the like is displayed on the display 132) in the image forming apparatus 12, or in a case where, for example, an ID card (such as an employee ID or a membership card) other than the user terminal 200 is held over the short distance communication unit 142, the state of the image forming apparatus 12 may not be shifted to the second state even when the operation by which short distance wireless communication is started is performed.

As above, it is possible to perform transmission/reception of communication data also by short distance wireless communication, so that the state of the image forming apparatus 12 may be shifted to the first state when a data amount of communication data which is to be transmitted/received between the user terminal 200 and the image forming apparatus 12 is small.

In the second exemplary embodiment, short distance wireless communication of an NFC method has been described as an example, but there is no limitation thereto. For example, a Bluetooth method is able to be adopted instead of the NFC method. In this case, the short distance communication unit 142 of the image forming apparatus 12 and the short distance communication unit of the user terminal 200 perform transmission/reception of communication data by short distance wireless communication of the Bluetooth method.

### Third Exemplary Embodiment

Since the information processing system 10 of a third exemplary embodiment is the same as that of the first exemplary embodiment except that the wireless communication unit 140 is to be stopped under a predetermined condition when the wireless communication unit 140 is activated, a content different from that of the first exemplary embodiment will be described and duplicate description will be omitted.

In the third exemplary embodiment, when the image forming apparatus 12 is in the second state, it is determined whether or not wireless communication is being performed. Wireless communication is performed when, after wireless communication connection is established between the user terminal 200 and the image forming apparatus 12, the user terminal 200 exists within a predetermined distance (within a predetermined range) where a wireless signal transmitted from the antenna of the wireless communication unit 140 is able to be received.

On the other hand, wireless communication is not performed when the user terminal 200 exists out of the range where the wireless signal is able to be received. Even in a case where the user terminal 200 exists within the range where the wireless signal is able to be received, when a power source of the user terminal 200 is turned off or an offline mode is set in the user terminal 200, wireless communication is not performed.

Then, in a case where, when the image forming apparatus 12 is in the second state, a state in which wireless communication is not performed continues for a predetermined time (for example, three to five minutes), the state of the image forming apparatus 12 is shifted to the first state. That is, supply of power to the wireless communication unit 140 is stopped and wireless communication is not allowed.

On the other hand, in a case where, when the image forming apparatus 12 is in the second state, wireless communication is being performed, the second state is maintained. That is, a state in which the wireless communication unit 140 is activated is maintained.

In order to realize an operation of the information processing system 10 as described above, an information processing program of the image forming apparatus 12 in the third exemplary embodiment includes a determination program that determines whether or not wireless communication is being performed. When a state in which it is determined, in accordance with the determination program, that wireless communication is not being performed continues for a predetermined time, the CPU 122 shifts the state of the image forming apparatus 12 from the second state to the first state in accordance with the communication control program 302d.

Hereinafter, communication processing in the third exemplary embodiment will be described by using a flowchart, and processing that is the same as the communication processing described in the first exemplary embodiment will be given the same reference sign and duplicate description will be omitted or simplified.

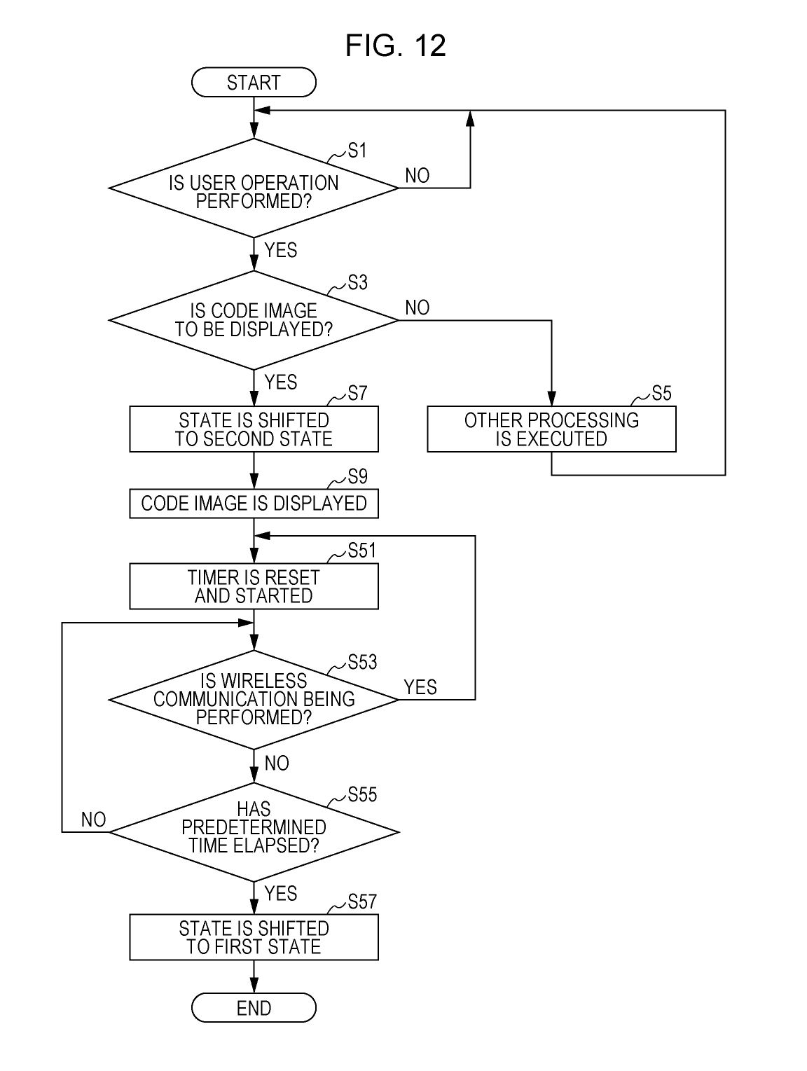

FIG. 12 is a flowchart illustrating an example of the communication processing of the third exemplary embodiment. As illustrated in FIG. 12, when starting the communication processing, the CPU 122 of the image forming apparatus 12 displays the code image 112 on the display 132 at step S9, and resets and starts a timer at step S51. Note that, the timer is a timer for counting a duration time from when it is determined that the wireless communication is not being performed, and though illustration is omitted, the timer is provided in an inside (the CPU 122 or the RAM 124) of the image forming apparatus 12.

Next, at step S53, it is determined whether or not wireless communication is being performed. In a case of “YES” at step S53, that is, when wireless communication is being performed, the procedure returns to step S51. On the other hand, in a case of “NO” at step S53, that is, when wireless communication is not being performed, at step S55, it is determined, by referring to the timer, whether or not a predetermined time has elapsed.

In a case of “NO” at step S55, that is, when the predetermined time has not elapsed, the procedure returns to step S53. On the other hand, in a case of “YES” at step S55, that is, when the predetermined time has elapsed, the state is shifted to the first state at step S57 and the communication processing ends.

Note that, contents of processing up to step S7 is the same as those of the first exemplary embodiment, so that the description thereof will be omitted.

According to the third exemplary embodiment, in the case where, when the image forming apparatus 12 is in the second state, the state in which wireless communication is not performed continues for a predetermined time, the wireless communication unit 140 is to be stopped. Thus, the wireless communication unit 140 is activated only when desired, so that it is possible to achieve power saving more appropriately.

Note that, an aspect described in the third exemplary embodiment is able to be adopted also into the second exemplary embodiment in combination.

A numerical value, a screen, a specific configuration, and the like that are given in the exemplary embodiments described above are merely examples and are able to be appropriately changed in accordance with an actual product. Additionally, an order of the processing at the steps of each of the flowcharts described in the exemplary embodiments above is able to be appropriately changed as long as the same result is obtained.

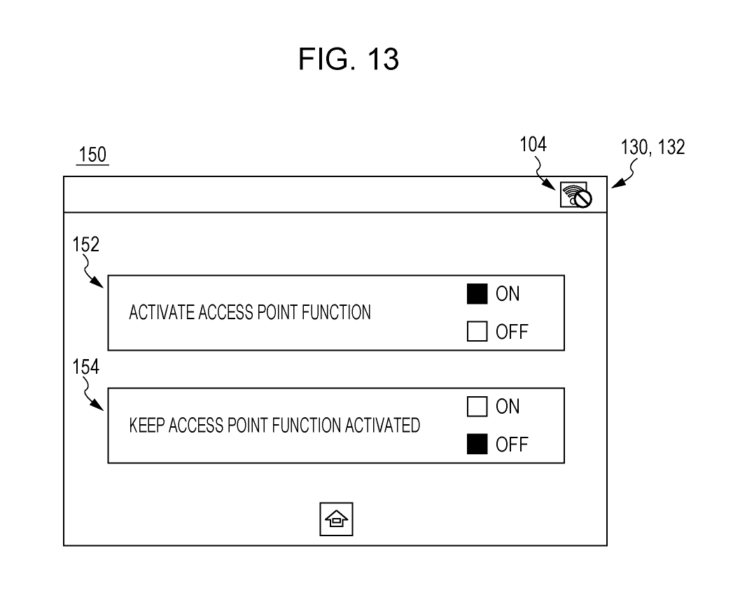

Moreover, whether or not to activate the wireless communication unit 140 may be set in advance. For example, a setting screen 150 as illustrated in FIG. 13 is displayed on the display 132. On the setting screen 150, a setting icon 152 for setting whether or not to activate an access point function of wireless communication and a setting icon 154 for setting whether or not to keep the access point function activated are displayed. A check box for selecting ON/OF of the function is provided in each of the setting icons 152 and 154 and setting is changed in accordance with a user operation.

For example, when the setting as to whether or not to activate the access point function of wireless communication is OFF, the wireless communication unit 140 is kept stopped. In this case, the check box of the setting icon 154 is set so as not to be selected.

On the other hand, when the setting as to whether or not to activate the access point function of wireless communication is ON, the check box of the setting icon 154 is able to be selected. When the setting as to whether or not to keep the access point function activated is ON, the wireless communication unit 140 is kept activated. On the other hand, the setting as to whether or not to keep the access point function activated is OFF, the wireless communication unit 140 is activated or stopped in accordance with a status of the image forming apparatus 12 by the aforementioned method.

The present disclosure contains subject matter related to that disclosed in Japanese Priority Patent Application JP 2017-088556 filed in the Japan Patent Office on Apr. 27, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
a wireless communication unit configured to perform wireless communication with a portable terminal;
an operation determination unit configured to determine whether or not a first operation by which the image forming apparatus is caused to execute a function that includes the wireless communication is performed; and
a communication control unit configured to shift a state of the wireless communication unit from a first state in which the wireless communication is not allowed to a second state in which the wireless communication is allowed, in a case where the operation determination unit determines that the first operation is performed.

2. The image forming apparatus according to claim 1, further comprising:
a display; and
a display unit configured to display a code image on the display in accordance with a user operation, wherein
the operation determination unit determines that the first operation is performed, in a case where the user operation by which the code image is displayed on the display is performed.

3. The image forming apparatus according to claim 1, further comprising
a short distance wireless communication unit by which short distance wireless communication is performed with the portable terminal, wherein
the operation determination unit determines that the first operation is performed, in a case where an operation by which the short distance wireless communication is started in the short distance wireless communication unit is performed.

4. The image forming apparatus according to claim 1, further comprising
a determination unit configured to determine whether or not the wireless communication is being performed with the portable terminal, wherein
the communication control unit shifts the state of the wireless communication unit to the first state, in a case where a state in which the determination unit determines that the wireless communication is not being performed continues for a predetermined time in the second state.

5. A non-transitory computer readable medium storing a program causing a computer to execute a process for controlling an image forming apparatus including a wireless communication unit configured to perform wireless communication with a portable terminal, the process comprising:
causing a processor of the image forming apparatus to function as
an operation determination unit configured to determine whether or not a first operation by which the image forming apparatus is caused to execute a function that includes the wireless communication is performed and
a communication control unit configured to shift a state of the wireless communication unit from a first state in which the wireless communication is not allowed to a second state in which the wireless communication is allowed, in a case where the operation determination unit determines that the first operation is performed.

6. A control method, wherein
a processor of an image forming apparatus that includes a wireless communication unit configured to perform wireless communication with a portable terminal executes
(a) determining whether or not a first operation by which the image forming apparatus is caused to execute a function that includes the wireless communication is performed, and
(b) shifting a state of the wireless communication unit from a first state in which the wireless communication is not allowed to a second state in which the wireless communication is allowed, in a case where it is determined, at (a), that the first operation is performed.
